(19) United States
(12) Patent Application Publication
(10) Pub. No.: US 2013/0039064 A1
(43) Pub. Date: Feb. 14, 2013

(54) LIGHT EMITTING DIODE BULB

(71) Applicant: MIN-JET LUI, Chu-Nan (TW)

(72) Inventor: MIN-JET LUI, Chu-Nan (TW)

(73) Assignee: FOXSEMICON INTEGRATED TECHNOLOGY, INC., Chu-Nan (TW)

(21) Appl. No.: 13/304,702

(22) Filed: Nov. 28, 2011

(30) Foreign Application Priority Data
Aug. 9, 2011 (TW) 100128438

(51) Int. Cl. F21V 29/00; F21V 21/00

(52) U.S. Cl. 362/249.02

(57) ABSTRACT

A light emitting diode bulb includes a holder; a housing connected with the holder; an LED module arranged on the housing and electrically connected with the holder. The LED module comprises a base and LED units formed on the base. The base has an upper surface and lateral surfaces extending downwardly and slanted to the upper surface. The LED units are arranged on the upper surface and the lateral surfaces respectively. An envelope is formed on the housing opposite to the holder. Light from the LED units of the LED module passes through the envelope and transmits to an external environment along different directions.

### 1. TECHNICAL FIELD

The disclosure generally relates to an illumination device, and particularly relates to a light emitting diode bulb.

### 2. DESCRIPTION OF RELATED ART

In recent years, due to excellent light quality and high luminous efficiency, light emitting diodes (LEDs) have increasingly been used as substitutes for incandescent bulbs, compact fluorescent lamps and fluorescent tubes as light sources of illumination devices.

An LED bulb generally includes a printed circuit board and a number of LEDs arranged on the printed circuit broad. However, because the printed circuit board is generally flat, light beams from the LED units are all emitted to an external environment in a same direction. Therefore, an illuminating angle of the LED bulb is relatively smaller than the traditional incandescent bulbs.

Therefore, an LED bulb is desired to overcome the above described shortcomings.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric view of an LED bulb in accordance with an embodiment of the present disclosure.

FIG. 2 is an exploded view of the LED bulb in FIG. 1.

FIG. 3 is an enlarged, isometric view of a mounting base of the LED bulb in FIG. 2, which is inverted relative to that shown in FIG. 2.

FIG. 4 is a cross-sectional view of the LED bulb in FIG. 1.

### DETAILED DESCRIPTION

An embodiment of an LED bulb will now be described in detail below and with reference to the drawings.

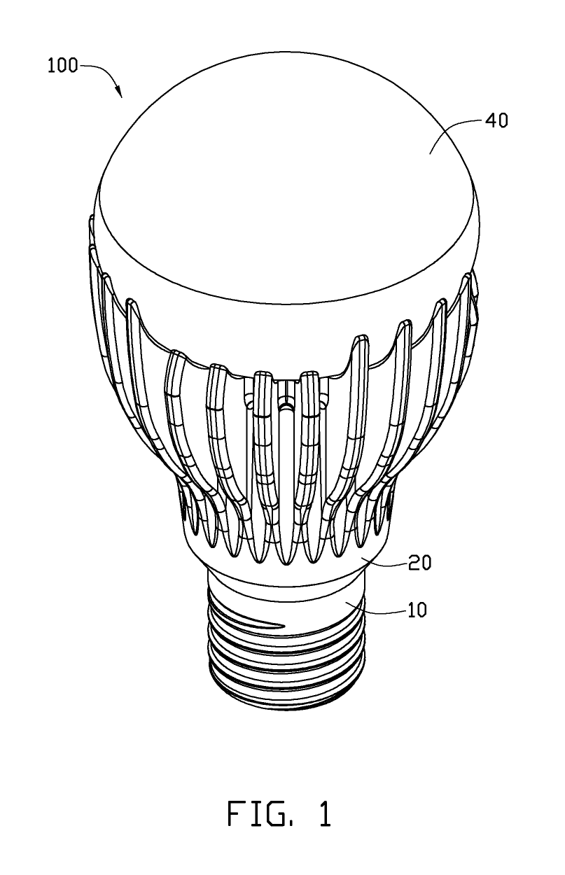

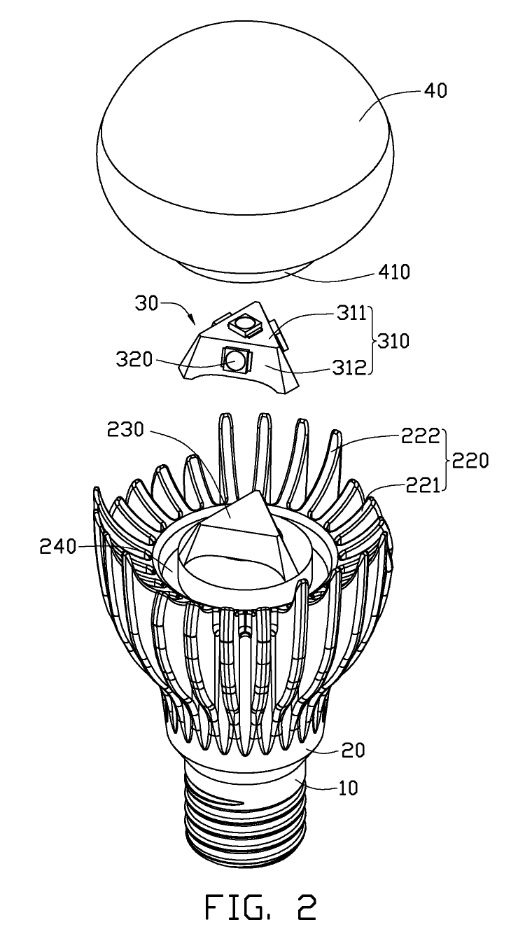

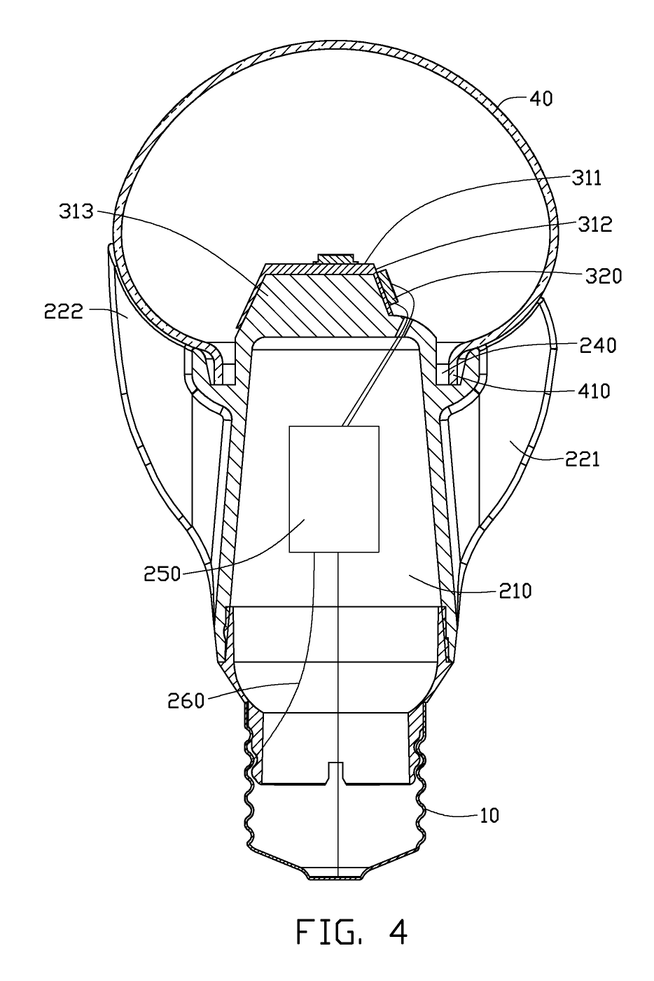

Referring to FIGS. 1-4, an LED bulb 100 in accordance with an embodiment of the present disclosure includes a holder 10, a housing 20 connected to the holder 10, an LED module 30 arranged on the housing 20 and electrically connected to the holder 10, and an envelope 40 arranged on the housing 20 and covering the LED module 30.

The holder 10 can be a standard holder, for example, an Edison holder such as E27, etc., for conveniently connection with a light bulb socket or other elements which supply electrical power to the holder 10.

The housing 20 has a bottom end connected to the holder 10. The housing 20 has a cross section being generally n-shaped, and defines a space 210 therein to receive a driving circuit 250 and wires 260 therein. The housing 20 is made of thermally conductive materials, such as ceramic and metal. The housing 20 includes a number of fins 220 extending outwardly from a periphery of the housing 20 and surrounding the space 210. A top surface of each fin 220 is beyond a top of the housing and is concave, which extends to contact an outer surface of the envelope 40. Therefore, part of heat of the envelope 40 can be transferred to an outer environment through the fins 220. A length of each of the fins 220 along a radial direction of the housing 20 gradually increases with a distance from the holder 10.

In this embodiment, the fins 220 include three groups of short fins 221 and three groups of long fins 222. A length of the short fins 221 along a longitudinal direction of the housing 20 is less than that of the long fins 222. The groups of short fins 221 and long fins 222 are arranged alternately around the housing 20. That is, each group of the long fins 222 is arranged between two adjacent groups of the short fins 221, and similarly, each group of the short fins 221 is arranged between two adjacent groups of the long fins 222. A supporting section 230 is formed on an upper surface of a center of the housing 20 for supporting the LED modules 30. In this embodiment, the supporting section 230 is a truncated pyramid, and is integrally formed with the housing 20 as one monolithic piece. A bottom surface of the supporting section 230 is joined to the housing 20, and a cross-sectional area of the supporting section 230 gradually decreases with a distance from the holder 10. In other words, the cross-sectional area of the supporting section 230 is gradually decreased along a bottom-to-top direction. An annular groove 240 is formed around the supporting section 230 to receive a fringe of the envelope 40, therefore securing the envelope 40 to the housing 20. In this embodiment, the housing 20 is formed by extrusion molding or die casting.

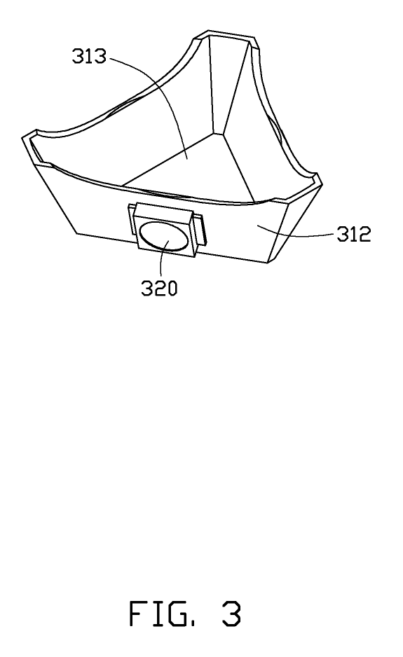

The LED module 30 includes a base 310 and LED units 320 arranged on the base 310. Referring also to FIG. 3, the base 310 includes an upper surface 311 and three lateral surfaces 312 extending downwardly and slanted to the upper surface 311. A receiving chamber 313 is defined under the upper surface of the base 310 and surrounded by the three lateral surfaces 312. A shape of the receiving chamber 313 corresponds to that of the supporting section 230 of the housing 20 to receive the supporting section 230 therein; therefore the LED module 30 can be fittingly secured onto the supporting section 320 of the housing 20. The LED units 320 are electrically connected with the driving circuit 250. In this embodiment, each group of the short fins 221 is arranged at a position directly facing one of the LED units 320 arranged on the lateral surface 312, and each group of the long fins 222 is arranged between two adjacent groups of the short fins 221. Therefore, light from the LED units 320 will not be blocked by the fins 220 and light extraction efficiency of the LED bulb 100 is improved. A cross-sectional area of the base 310 gradually decreases with a distance from the holder 10. Also, an opening of the receiving chamber 313 tapers from the bottom of the base 310 to the upper surface 311, thereby receiving the truncated supporting section 230 therein. An included angle between the upper surface 311 and the lateral surfaces 312 is about 120 degrees. In other embodiments, the included angle between the upper surface 311 and the lateral surfaces 312 ranges from 115 degrees to 135 degrees for forming a predetermined light distribution. The base 310 is made of thermally conductive materials, such as ceramic and metal. Heat from the LED units 320 can be transferred to the external environment via the supporting section 230 and the fins 220. Preferably, materials of the base 310 are selected from a group consisting of Cu, Al, Fe, Ni, Zn or an alloy thereof. Also, the base 310 can be made of ceramic such as Si, SiC, SiN and ZnO. In alternative embodiments, the base 310 can be directly secured on the housing 20 without employing the supporting section 230.

The envelope 40 is arranged on an upper end of the housing 20 away from the holder 10. Light from the LED module 30 passes through the envelope 40 and reaches the external environment. In this embodiment, the envelope 40 has a bulb-shaped configuration, and a fringe 410 is formed at a bottom of the envelope 40 adjacent to the housing 20. The fringe 410 is embedded in the annular grooves 240; therefore the envelope 40 is secured to the housing 20. In this embodiment, the fringe 410 is adhered to the annular grooves 240 by adhesive materials. In another embodiment, outer threads can be formed on the peripheral surface of the fringe 410, and inner threads can be formed on the inner surface of the annular grooves 240. The outer threads and the inner threads engage with each other thereby securing the envelope 40 to the housing 20. The envelope 40 is made of transparent materials such as polycarbonate (PC), polymethyl methacrylate (PMMA) or glass. In addition, the envelope 40 can be doped with phosphor materials therein to change the color of the light emitted by the LED units 320. The phosphor materials can be fluorescent substances with garnet structure, nitrides, phosphide, sulfide or silicate. And, the phosphor materials can be directly applied on an inner surface or an outer surface of the envelope 40.

Because the upper surface 311 and the lateral surfaces 312 are oriented to different directions, the LED units 320 arranged on the upper surface 311 and the lateral surfaces 312 will emit light beams in respective directions different from each other. Therefore, the LED bulb 100 has a relatively wide illuminating angle which corresponds to that of the traditional incandescent bulb.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A light emitting diode bulb, comprising:
a holder;
a housing connected with the holder;
an LED module arranged on the housing and electrically connected with the holder, the LED module comprising a base and LED units formed on the base, the base having an upper surface and lateral surfaces extending downwardly and slanted to the upper surface, the LED units being arranged on the upper surface and the lateral surfaces respectively; and
an envelope formed on the housing and covering the LED module, light from the LED units of the LED module passing through the envelope to an external environment.

2. The light emitting diode bulb of claim 1, wherein the base is truncated, a bottom surface of the base is secured to the housing and a cross-sectional area of the base gradually decreases from the bottom surface to the upper surface of the base.

3. The light emitting diode bulb of claim 1, wherein the base is made of ceramic.

4. The light emitting diode bulb of claim 1, wherein the base is made of metal.

5. The light emitting diode bulb of claim 1, wherein the housing comprises a plurality of fins extending outwardly from the housing, and a length of each of the fins along a radial direction of the housing gradually increases with a distance from the holder.

6. The light emitting diode bulb of claim 5, wherein the envelope is bulb-shaped, a top end of each fin being curve-shaped and contacting an outer surface of the envelope.

7. The light emitting diode bulb of claim 6, wherein the fins comprise several groups of short fins and several groups of long fins, and a length of the short fins along a longitudinal direction of the housing is less than that of the long fins.

8. The light emitting diode bulb of claim 7, wherein the groups of the short fins and the groups of the long fins are arranged alternately around the housing.

9. The light emitting diode bulb of claim 7, wherein each group of the short fins is arranged at a position directly facing one of the lateral surface, and each group of the long fins is arranged between two adjacent groups of the short fins.

10. The light emitting diode bulb of claim 1, wherein a receiving chamber is defined among the lateral surfaces and under the upper surface of the base, and the housing comprises a supporting section fittingly received in the receiving chamber to secure the base to the housing.

11. The light emitting diode bulb of claim 1, wherein an included angle between the upper surface and each of the lateral surfaces ranges from 115 degrees to 135 degrees.

12. A light emitting diode bulb, comprising:
a holder;
a housing connected with the holder;
an LED module formed on the housing and electrically connected with the holder, the LED module comprising a base and LED units formed on the base, the base having a plurality of surfaces oriented to different directions, the LED units being arranged on the surfaces respectively; and
an envelope formed on the housing opposite to the holder, light from the LED module passing through the envelope and transmitting to an external environment.

13. The light emitting diode bulb of claim 12, wherein the base is truncated, a bottom surface of the base is secured to the housing and a cross-section area of the base gradually decrease from the bottom surface to an upper surface of the base.

14. The light emitting diode bulb of claim 12, wherein the housing comprises a plurality of fins extending outwardly from the housing, and a length of each of the fins along a radial direction of the housing gradually increases with a distance from the holder.

15. The light emitting diode bulb of claim 14, wherein the envelope is bulb-shaped, a top end of each fin being curve-shaped and extending to contact an outer surface of the envelope.

16. The light emitting diode bulb of claim 15, wherein the fins comprise several groups of short fins and several groups of long fins, and a length of each of the short fins along a longitudinal direction of the housing is less than that of each of the long fins.

17. The light emitting diode bulb of claim 16, wherein the groups of the short fins and the groups of the long fins are arranged alternately around the housing.

18. The light emitting diode bulb of claim 16, wherein each group of the short fins is arranged at a position directly facing one of lateral surfaces of the base, and each group of the long fins is arranged between two adjacent groups of the short fins.
